(19) United States
(12) Patent Application Publication
(10) Pub. No.: US 2024/0356042 A1
(43) Pub. Date: Oct. 24, 2024

(54) HYBRID ANODE AND A SOLID-STATE BATTERY CELL MADE THEREFROM

(71) Applicant: Solid Power Operating, Inc., Louisville, CO (US)

(72) Inventors: Haitao HUANG, Broomfield, CO (US); Ian A. MORRISSEY, Boulder, CO (US); Levi SCHUTT, Denver, CO (US); Pu ZHANG, Boulder, CO (US)

(21) Appl. No.: 18/645,297

(22) Filed: Apr. 24, 2024

Related U.S. Application Data
(60) Provisional application No. 63/461,526, filed on Apr. 24, 2023.

(51) Int. Cl. H01M 4/62; H01M 4/02; H01M 4/04; H01M 4/1395; H01M 4/36; H01M 4/38

(52) U.S. Cl. CPC H01M 4/628; H01M 4/0404; H01M 4/1395; H01M 4/366; H01M 4/382; H01M 2004/021

(57) ABSTRACT

Provided herein are compositions for solid-state electrochemical cells that include a first layer and a second layer which meet at an interface. Each layer includes a binder, wherein the binder concentration forms a continuous gradient across the interface. Further provided herein are methods of making the compositions.

### CROSS-REFERENCE TO RELATED APPLICATION

This application is related to and claims priority under 35 U.S.C. § 119(e) from U.S. Patent Application No. 63/461,526 filed Apr. 24, 2023, titled “Hybrid Anode and a Solid-State Battery Cell Made Therefrom,” the entire contents of which are incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions. In these anodes, lithium ions are stored by intercalating between planes of carbon atoms that compose graphite particles. Carbon-based anodes have been tailored to confer acceptable performance in modern lithium-ion batteries. However, carbon-based anodes are reaching maturity in terms of their lithium-ion storage.

An alternative to the carbon-based anode is an alloy-type anode. In the alloy-type anode, rather than intercalating between sheets of carbon in graphite particles, the lithium ions alloy with the active anode material. These materials may have up to ten times (10×) more lithium-ion storage capacity as compared to that of graphite anodes. The typical alloy-type anodes include silicon, tin, and aluminum, as well as more exotic materials, such as germanium and gold. These alloy materials have their own advantages and disadvantages, such as cost, specific capacity, processability, and voltage penalty.

One of the challenges to confront in these systems is the volume change associated with alloying lithium with the active material. For example, volume changes near 400% can happen with some systems. The volume change can cause difficulties from a macro and micro level. At the macro level, a battery pack may have to accommodate a swelling cell, and at the micro level, the continuous expansion and contraction of the active area can lead to cracking. The particles in the active area then can lose electrical connection with their surrounding matrix and can also undergo undesirable side reactions between the fresh surfaces of the particles and the battery electrolyte.

Although progress has been made in the field of lithium batteries, there remains a need in the art for a solid-state anode that is more resistive to cracking and that has improved coulombic efficiency.

### SUMMARY

Provided herein are compositions for use in electrical cells. Generally, the compositions include a first current collector layer; a first interlayer having a thickness of about 1 micron to about 10 microns; a second interlayer having a thickness of about 1 micron to about 10 microns; a separator layer; a cathode layer; and a second current collector layer. The first interlayer and the second interlayer are positioned between the first current collector layer and the separator layer. In some embodiments, the electrochemical cell has a stack pressure of about 300 psi or less. In some embodiments, the first current collector layer comprises copper and a thin layer of copper oxide.

In some embodiments, the first interlayer comprises a mixture of carbon materials. In some embodiments, the first interlayer comprises a metal selected from the group consisting of silver, zinc, aluminum, magnesium, tin, antimony, and combinations thereof. In some aspects, the metal has a concentration in the first interlayer from about 5 wt % to about 50 wt %. In some particular aspects, the metal has a concentration in the first interlayer of about 30 wt %. In some aspects, the metal has an average particle size of less than about 900 nm. In some embodiments, the first interlayer comprises a metal carbide selected from the group consisting of silicon carbide (SiC), titanium carbide (TiC), tungsten carbide (WC). In some aspects, the metal carbide has an average particle size of less than about 1 μm. In some embodiments, the first interlayer comprises a binder.

In some embodiments, the second interlayer comprises silicon. In some embodiments, the second interlayer comprises carbon materials. In some embodiments, the second interlayer comprises a binder.

In some embodiments, the first interlayer and the second interlayer are free of lithium (Li). In some aspects, the first interlayer and the second interlayer are free of lithium (Li) before the electrochemical cell is first cycled. In some embodiments, the first interlayer has a porosity of about 20% to about 50%. In some embodiments, the second interlayer has a porosity of about 20% to about 50%. In some embodiments, the thickness of the first interlayer and the second interlayer is measured before densification.

In some embodiments, the separator layer comprises a solid electrolyte material. In some aspects, the solid electrolyte material is a sulfide solid electrolyte material.

In some embodiments, the cathode layer comprises a cathode active material. In some aspects, the cathode active material comprises a coated or uncoated metal sulfide, a fluoride, and/or nickel-manganese-cobalt. In some additional aspects, the cathode active material comprises lithium. In some embodiments, the cathode layer comprises a conductive additive. In some embodiments, the cathode layer comprises a binder. In some embodiments, the cathode layer comprises a solid electrolyte material.

In some embodiments, the first interlayer is operably coupled with the first current collector layer. In some embodiments, the first interlayer is operably coupled with the second interlayer. In some embodiments, the separator layer is operably coupled with the second interlayer. In some embodiments, the cathode layer is operably coupled with the separator layer, and the separator layer is positioned between the second interlayer and the cathode layer. In some embodiments, the second current collector layer is operably coupled with the cathode layer.

In some embodiments, the composition further includes a plating layer comprising lithium metal. In some embodiments, the plating layer is positioned between the first interlayer and the second interlayer. In some embodiments, the plating layer is positioned between the second interlayer and the separator layer.

Further provided herein are compositions for use in an electrochemical cell, the compositions comprising: a first current collector layer; an interlayer having a thickness of about 1 micron to about 10 microns; a separator layer; a cathode layer; and a second current collector layer. The interlayer is positioned between the first current collector layer and the separator layer.

In some embodiments, the interlayer comprises a metal selected from the group consisting of silver, zinc, aluminum, magnesium, tin, antimony, and combinations thereof. In some embodiments, the interlayer comprises a metal selected from the group consisting of silicon, tin, and combinations thereof. In some embodiments, the interlayer comprises a metal carbide selected from the group consisting of silicon carbide, titanium carbide, tungsten carbide, and combinations thereof.

In some embodiments, the interlayer has a porosity of about 20% to about 50%. In some embodiments, the thickness of the interlayer is measured before densification.

Further provided herein is a composition for use in an electrochemical cell, the composition comprising a first current collector layer; an anode layer, the anode layer comprising: a first interlayer having a thickness of about 1 micron to about 10 microns, and a second interlayer having a thickness of about 1 micron to about 10 microns; a separator layer; a cathode layer; and a second current collector layer.

In some embodiments, the anode layer is free of lithium. In some embodiments, the anode layer is free of lithium before the electrochemical cell is first cycled. In some additional embodiments, the anode layer comprises lithium after the electrochemical cell is cycled.

In some embodiments, the interlayer is operably coupled with the first current collector layer. In some embodiments, the separator layer is operably coupled with the interlayer. In some embodiments, the cathode layer is operably coupled with the separator layer, and the separator layer is positioned between the interlayer and the cathode layer. In some embodiments, the second current collector layer is operably coupled with the cathode layer.

Further provided herein are electrochemical cells comprising a first current collector layer; a first interlayer; a second interlayer; a separator layer; a cathode layer; and a second current collector layer. The anode layer is positioned between the first current collector layer and the separator layer. In some embodiments, the electrochemical cell has a stack pressure of about 300 psi or less.

In some embodiments, the first interlayer and the second interlayer are free of lithium (Li) before the electrochemical cell is first cycled. In some embodiments, the first interlayer and/or the second interlayer comprise lithium after the electrochemical cell is first cycled.

In some embodiments, the electrochemical cell has a specific capacity of greater than 50 mAh/g after about 30 cycles. In some embodiments, the electrochemical cell has a specific capacity of greater than 70 mAh/g after about 30 cycles. In some embodiments, the electrochemical cell has a capacity greater than 80% of its initial capacity after being cycled about 50 times or more, about 100 times or more, or about 150 times or more. In some embodiments, the electrochemical cell has a coulombic efficiency of greater than about 80%, about 90%, about 95%, or about 98% after being cycled about 20 times or more or about 40 times or more.

In some embodiments, the anode layer is operably coupled with the first current collector layer. In some embodiments, the first interlayer is operably coupled with the second interlayer. In some embodiments, the separator layer is operably coupled with the anode layer. In some embodiments, the cathode layer is operably coupled with the separator layer, and the separator layer is positioned between the anode layer and the cathode layer. In some embodiments, the second current collector layer is operably coupled with the cathode layer.

In some embodiments, the composition further includes a plating layer comprising lithium metal. In some embodiments, the plating layer is positioned between the first interlayer and the second interlayer. In some embodiments, the plating layer is positioned between the second interlayer and the separator layer.

Further provided herein is an electrochemical cell comprising: a first current collector layer; an interlayer; a separator layer; a cathode layer; and a second current collector layer. The first interlayer and the second interlayer are positioned between the first current collector layer and the separator layer.

In some embodiments, the composition further includes a plating layer comprising lithium metal. In some embodiments, the plating layer is positioned between the interlayer and the separator layer.

Further provided herein is an electrochemical cell comprising: a first current collector layer; an anode layer including a first interlayer and a second interlayer; a separator layer; a cathode layer; and a second current collector layer. The anode layer is positioned between the first current collector layer and the separator layer.

Further provided herein is a method of making an electrochemical cell, the method comprising: coating a first interlayer composition onto a first current collector; coating a second interlayer composition onto the first interlayer composition, thereby forming a first portion of the electrochemical cell; and laminating the first portion of the electrochemical cell with a second portion of the electrochemical cell.

Further provided herein is a method of making an electrochemical cell, the method comprising coating a first interlayer composition onto a carrier foil; transferring the first interlayer composition from the carrier foil to a first current collector via lamination; coating a second interlayer composition onto the first interlayer composition, thereby forming a first portion of the electrochemical cell; and laminating the first portion of the electrochemical cell with a second portion of the electrochemical cell.

Further provided herein is a method of making an electrochemical cell, the method comprising coating a first interlayer composition onto a carrier foil; transferring the first interlayer composition from the carrier foil to a first current collector via lamination; coating a second interlayer composition onto a carrier foil; transferring the second interlayer composition onto the first interlayer composition, thereby forming a first portion of the electrochemical cell; and laminating the first portion of the electrochemical cell with a second portion of the electrochemical cell.

Further provided herein is a method of making an electrochemical cell, the method comprising coating a first interlayer composition onto a carrier foil; transferring the first interlayer composition from the carrier foil to a first current collector via lamination, thereby forming a first portion of an electrochemical cell; coating a second interlayer composition onto a solid electrolyte composition, thereby forming a second portion of the electrochemical cell; and laminating the first portion and the second portion such that the first interlayer composition and the second interlayer composition are in physical contact.

Further provided herein is a method of making an electrochemical cell, the method comprising coating an interlayer composition onto a first current collector, thereby forming a first portion of the electrochemical cell; and laminating the first portion of the electrochemical cell with a second portion of the electrochemical cell.

Further provided herein is a method of making an electrochemical cell, the method comprising coating an interlayer composition onto a carrier foil; transferring the interlayer composition from the carrier foil to a first current collector via lamination, thereby forming a first portion of the electrochemical cell; and laminating the first portion of the electrochemical cell with a second portion of the electrochemical cell.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIGS. 1A-1D show diagrams of the double-interlayer compositions of the present disclosure. FIG. 1A is a cross-sectional diagram of the compositions of the present disclosure. FIG. 1B is a cross-sectional diagram of the compositions of the present disclosure including a zoomed in view of a portion of the cross-sectional diagram. FIG. 1C is a cross-sectional diagram of the compositions of the present disclosure, wherein the composition includes a plated layer at the interface of the first interlayer and the second interlayer. FIG. 1D is a cross-sectional diagram of the compositions of the present disclosure, wherein the composition includes a plated layer at the interface of the second interlayer and the separator layer.

FIGS. 2A and 2B show diagrams of the single-interlayer compositions of the present disclosure. FIG. 2A is a cross-sectional diagram of the compositions of the present disclosure, and FIG. 2B is a cross-sectional diagram of the compositions of the present disclosure, wherein the composition includes a plated layer at the interface of the interlayer and the separator layer.

FIG. 3 shows cycling data of an exemplary electrochemical cell comprising the compositions of the present disclosure.

FIG. 4 shows the specific capacity of an exemplary electrochemical cell comprising the compositions of the present disclosure.

FIG. 5 shows the capacity of an exemplary electrochemical cell comprising the compositions of the present disclosure.

FIGS. 6A and 6B show cycling data of exemplary electrochemical cells comprising compositions of the present disclosure. Cell #1 includes silicon and silver while Cell #2 includes only silicon. FIG. 6A shows the specific capacity of the electrochemical cells. FIG. 6B shows the coulombic efficiency of the electrochemical cells.

FIG. 7 shows cycling data of exemplary electrochemical cells comprising compositions of the present disclosure.

FIGS. 8A and 8B show the specific capacity and the coulombic efficiency of electrochemical cells that include a single interlayer of the present disclosure. Cell #1 includes an interlayer comprising silicon, silver, carbon, and polyamide-imide (PAI). Cell #2 includes an interlayer comprising silicon, silver, silicon carbide, and PAI.

FIG. 9 is an SEM image showing the lithium metal plating behavior of the second solid state electrochemical cell of Example 5 wherein the interlayer contains a silicon carbide material.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Provided herein are compositions for use in an electrochemical cell comprising one or more hybrid anode layers, also referred to herein as “interlayers”. The interlayers are generally lithium-free interlayers and include materials that alloy with lithium and promote lithium plating. The volume expansion of the materials that occurs with lithium alloying may provide an internal pressure that sustains active particle-to-particle contact. This improves electron conduction and lithium ion movement through the layers, thereby improving electrical properties of the electrochemical cell such as cycle life.

### I. Compositions

### A. Double Interlayer Compositions

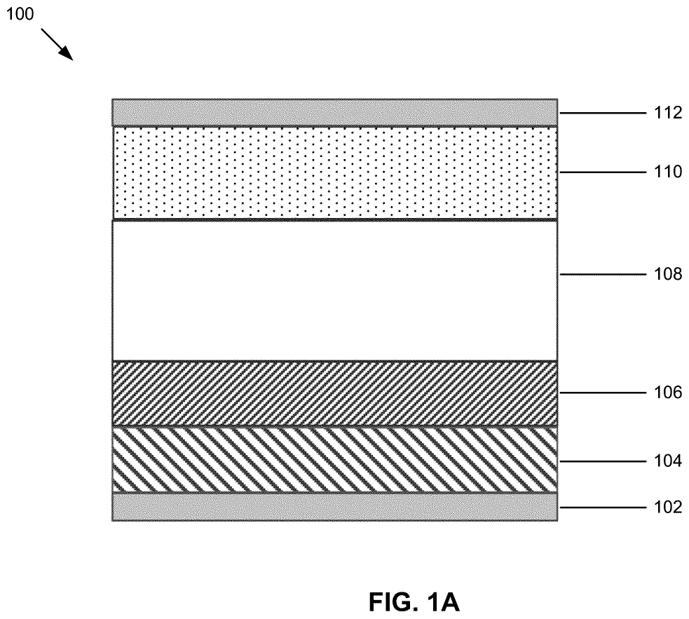

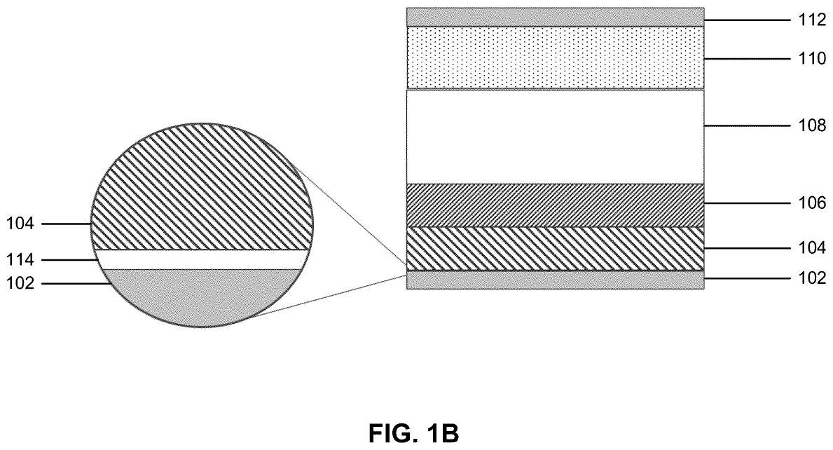

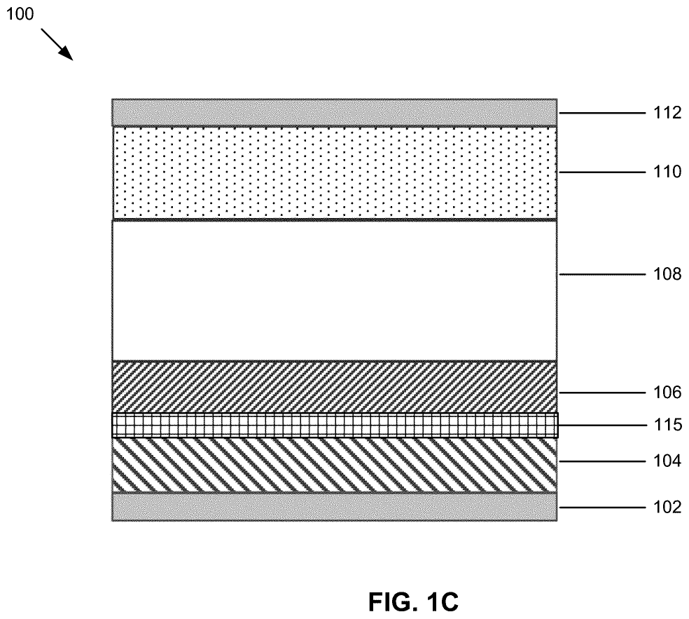

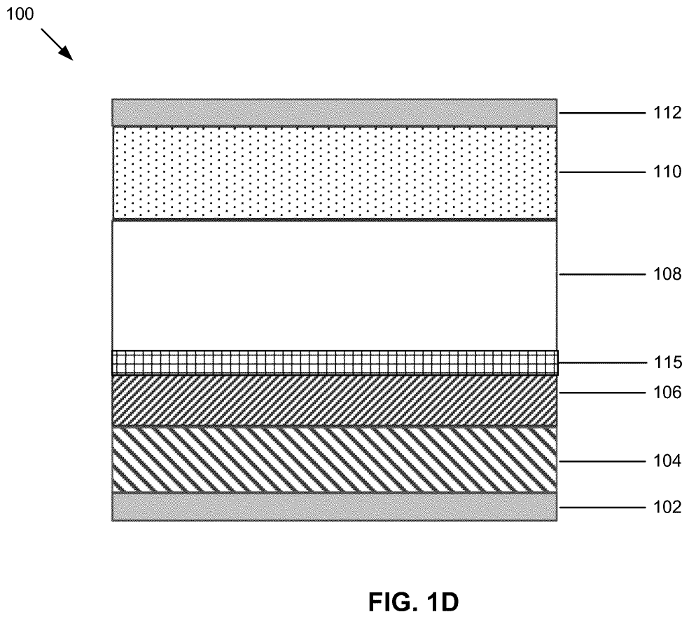

Referring now to FIG. 1A, the composition 100 may comprise a first current collector layer 102, a first interlayer 104, a second interlayer 106, a separator layer 108, a cathode layer 110, and a second current collector layer 112. Collectively, the first interlayer 104 and the second interlayer 106 may be referred to as an “anode layer.” Thus, the anode layer comprises the first interlayer 104 and the second interlayer 106.

As shown in FIG. 1A, the first interlayer 104 and the second interlayer 106 are positioned between the separator layer 108. The first interlayer 104 may be operably coupled with the first current collector layer 102. The first interlayer 104 may be operably coupled with the second interlayer 106. The separator layer 108 may be operably coupled with the second interlayer 106. The cathode layer 110 may be operably coupled with the separator layer 108, and the separator layer 108 is positioned between the second interlayer 106 and the cathode layer 110. The second current collector layer 112 may be operably coupled with the cathode layer 110.

The first current collector layer 102 may comprise a material that does not alloy with lithium. The first current collector layer 102 may comprise one or more of copper, aluminum, nickel, titanium, stainless steel, magnesium, iron, zinc, indium, germanium, silver, platinum, or gold. The first current collector layer 102 may also comprise a thin layer of oxidized material adjacent to the first interlayer 104. For example, the first current collector layer 102 may comprise a thin layer of copper oxide, aluminum oxide, nickel oxide, titanium oxide, magnesium oxide, iron oxide, zinc oxide, indium oxide, or germanium oxide. In some embodiments, the first current collector layer 102 may have a thickness from about 5 μm to about 10 μm. In some examples, the first current collector layer 102 includes a thin layer of carbon adjacent to the first interlayer 104.

In some additional examples, the first current collector layer 102 comprises copper and a thin layer of copper oxide. When the first current collector layer 102 does not include a thin layer of carbon, a thin layer of Li₂O 114 may form on the surface of the metal oxide on the first current collector layer, as shown in FIG. 1B. For example, when the surface of the first current collector 102 includes copper oxide, the Li₂O layer may form by the following reaction:

CuO+Li⁺→Cu⁺+Li₂O

The Li₂O material may not be removed or converted back to the oxidized metal; therefore, the Li₂O material will remain on the surface of the first current collector 102 for the life of the electrochemical cell. In some embodiments, the Li₂O layer may be visible using scanning electron microscopy.

The first interlayer 104 is in operable contact with the first current collector layer 102, and may be in physical contact with the first current collector layer 102. The first interlayer 104 may comprise a mixture of carbon materials. The mixture of carbon materials may include amorphous carbon, carbon black (C65), conducting graphite (e.g., SK6), and other forms of carbon. In a particular embodiment, the mixture of carbon materials includes carbon black and conducting graphite in a 1:1 weight ratio.

The first interlayer 104 may further comprise a metal selected from the group consisting of silver, zinc, aluminum, magnesium, tin, antimony, and combinations thereof. The metal may be present in the first interlayer 104 in an amount from about 0.1 mg/cm³ to about 1 mg/cm³. Without wishing to be bound by theory, it is believed that the carbon mixture facilitates conduction of electrons through the layer while the metal evenly distributes current density across the face of the first current collector layer 102. Preferably, the metal is in the form of a nanopowder. As used herein, a nanopowder is defined as a powder having an average particle size (i.e., D₅₀) of about 900 nm or less, such as about 500 nm or less. As used herein, a nanoparticle is a particle having a diameter of less than 1 micron. A nanopowder is comprised of a plurality of nanoparticles. The particle size may be measured visually by SEM.

The first interlayer 104 may further comprise a metal carbide such as silicon carbide (SiC) or titanium carbide (TiC), which may improve the durability of the first interlayer 104. Durability may be measured by the level of cohesion between the different materials in the first interlayer 104. Preferably, the metal carbide is in the form of a nanopowder.

Preferably, the first interlayer 104 is free of lithium prior to cycling in an electrochemical cell.

The first interlayer 104 may additionally comprise one or more binders. The binder aids in adhesion of the first interlayer 104 to the first current collector 102 and increases the structural integrity of the first interlayer 104. Additionally, the binder may enable improved cohesion between like particles in different layers of an electrochemical cell. The binder may also form a flexible matrix when mixed with a solid electrolyte material. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyamide-imide (PAI), polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In a preferred embodiment, the binder includes PVdF, PAI, or a combination thereof. In preferred embodiments where the first interlayer contains an electrolyte, the binder is a styrenic block copolymer. In an exemplary embodiment when the first interlayer contains an electrolyte, the binder is SEBS. In another exemplary embodiment, the binder comprises SEBS and SBS.

In some aspects, the binder may be present in the first interlayer 104 in an amount from about 0% to about 50% by weight of the first interlayer 104; for example, the binder may be present in the first interlayer 104 in an amount from about 0% to about 10%, about 0% to about 20%, about 0% to about 30%, about 0% to about 40%, about 0% to about 50%, about 10% to about 50%, about 20% to about 50%, about 30% to about 50%, or about 40% to about 50%. In an exemplary embodiment, the binder is present in the first interlayer 104 in an amount from about 10% to about 20% by weight.

The solid electrolyte material may be present in the first interlayer 104 in an amount from about 0% to about 60% by weight of the first interlayer. For example, the solid electrolyte material may be present in the first interlayer in an amount from about 0% to about 10%, about 0% to about 20%, about 0% to about 30%, about 0% to about 40%, about 0% to about 50%, about 0% to about 60%, about 10% to about 60%, about 20% to about 60%, about 30% to about 60%, about 40% to about 60%, about 50% to about 60%, about 10% to about 50%, or about 20% to about 40% by weight of the first interlayer. In some additional examples, the solid electrolyte material may be present in the first interlayer in an amount of about 0%, about 5%, about 10%, about 15%, about 20%, about 25%, about 30%, about 35%, about 40%, about 45%, about 50%, about 55%, or about 60% by weight of the first interlayer.

In another aspect, the solid electrolyte material may be present in the first interlayer 104 in an amount of no more than 60% (i.e., 60% or less), such as no more than 5%, no more than 10%, no more than 15%, no more than 20%, no more than 25%, no more than 30%, no more than 35%, no more than 40%, no more than 45%, no more than 50%, no more than 55%, or no more than 60% by weight of the first interlayer.

The first interlayer 104 may have a thickness from about 1 micron to about 10 microns before the first interlayer undergoes densification. For example, the first interlayer 104 may have a thickness of about 1 micron, about 2 microns, about 3 microns, about 4 microns, about 5 microns, about 6 microns, about 7 microns, about 8 microns, about 9 microns, or about 10 microns. In some aspects, the first interlayer 104 may have a thickness from about 1 micron to about 2 microns, about 1 micron to about 4 microns, about 1 micron to about 6 microns, about 1 micron to about 8 microns, about 1 micron to about 10 microns, about 2 microns to about 10 microns, about 4 microns to about 10 microns, about 6 microns to about 10 microns, or about 8 microns to about 10 microns.

The first interlayer 104 may have a porosity from about 20% to about 50%. For example, the first interlayer 104 may have a porosity from about 20% to about 25%, about 20% to about 30%, about 20% to about 35%, about 20% to about 40%, about 20% to about 45%, about 20% to about 50%, about 25% to about 50%, about 30% to about 50%, about 35% to about 50%, about 40% to about 50%, about 45% to about 50%, about 25% to about 45%, or about 30% to about 40%.

The first interlayer 104 may have a density from about 0.7 mg/cm³ to about 2 mg/cm³ after densification. For example, the first interlayer 104 may have a density from about 0.7 mg/cm³ to about 0.8 mg/cm³, about 0.7 mg/cm³ to about 0.9 mg/cm³, about 0.7 mg/cm³ to about 1.0 mg/cm³, about 0.7 mg/cm³ to about 1.1 mg/cm³, about 0.7 mg/cm³ to about 1.2 mg/cm³, about 0.7 mg/cm³ to about 1.3 mg/cm³, about 0.7 mg/cm³ to about 1.4 mg/cm³, about 0.7 mg/cm³ to about 1.5 mg/cm³, about 0.7 mg/cm³ to about 1.6 mg/cm³, about 0.7 mg/cm³ to about 1.7 mg/cm³, about 0.7 mg/cm³ to about 1.8 mg/cm³, about 0.7 mg/cm³ to about 1.9 mg/cm³, about 0.7 mg/cm³ to about 2.0 mg/cm³, about 0.8 mg/cm³ to about 2.0 mg/cm³, about 0.9 mg/cm³ to about 2.0 mg/cm³, about 1.0 mg/cm³ to about 2.0 mg/cm³, about 1.1 mg/cm³ to about 2.0 mg/cm³, about 1.2 mg/cm³ to about 2.0 mg/cm³, about 1.3 mg/cm³ to about 2.0 mg/cm³, about 1.4 mg/cm³ to about 2.0 mg/cm³, about 1.5 mg/cm³ to about 2.0 mg/cm³, about 1.6 mg/cm³ to about 2.0 mg/cm³, about 1.7 mg/cm³ to about 2.0 mg/cm³, about 1.8 mg/cm³ to about 2.0 mg/cm³, about 1.9 mg/cm³ to about 2.0 mg/cm³, about 1.0 mg/cm³ to about 2.0 mg/cm³, or about 1.0 mg/cm³ to about 1.5 mg/cm³ after densification.

The second interlayer 106 is in operable contact with the first interlayer 104 and may be in physical contact with the first interlayer 104. The second interlayer may comprise silicon. Preferably, the silicon is nanoscale silicon, i.e., silicon with a particle size of about 100 nm or less. In some aspects, the silicon may be present in an amount from about 0% to about 40% by weight of the first interlayer 104. For example, the silicon may be present in an amount from about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 10% to about 30%, or about 15% to about 25% by weight of the first interlayer 104. In another aspect, the silicon may be present in the second interlayer in an amount of no more than 5% (i.e., 5% or less), no more than 10%, no more than 15%, no more than 20%, no more than 25%, no more than 30%, no more than 35%, or no more than 40% by weight of the first interlayer.

The second interlayer 106 may further comprise a mixture of carbon materials. The mixture of carbon materials may include amorphous carbon, carbon black (C65), conducting graphite (e.g., SK6), and other forms of carbon. In a particular embodiment, the mixture of carbon materials includes carbon black and conducting graphite in a 1:1 weight ratio.

Preferably, the second interlayer 106 is free of lithium prior to cycling in an electrochemical cell.

The second interlayer 106 may additionally comprise one or more binders. The binder aids in adhesion of the second interlayer 106 to the first interlayer 104 and increases the structural integrity of the second interlayer 106. Additionally, the binder may enable improved cohesion between like particles in different layers of an electrochemical cell. The binder may also form a flexible matrix when mixed with a solid electrolyte material. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyamide-imide (PAI), polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In a preferred embodiment, the binder includes PVdF, PAI, or a combination thereof. In preferred embodiments where the second interlayer contains an electrolyte, the binder is a styrenic block copolymer. In an exemplary embodiment when the second interlayer contains an electrolyte, the binder is SEBS. In another exemplary embodiment, the binder comprises SEBS and SBS.

In some aspects, the binder may be present in the second interlayer 106 in an amount from about 0% to about 20% by weight of the second interlayer 106; for example, the binder may be present in the second interlayer 106 in an amount from about 0% to about 5%, about 0% to about 10%, about 0% to about 15%, about 5% to about 20%, about 10% to about 20%, or about 15% to about 20%. In an exemplary embodiment, the binder is present in the second interlayer 106 in an amount of about 4% to about 5% by weight.

The second interlayer 106 may further comprise a solid electrolyte material. The one or more solid electrolyte material may comprise an oxide, oxysulfide, sulfide, halide, nitride, or any other solid electrolyte material in the art. In some preferred embodiments, the one or more solid electrolyte materials may comprise a sulfide solid electrolyte material. In some embodiments, the solid electrolyte material comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, the solid electrolyte material may be one or more of a Li₃PS₄, Li₄P₂S₆, Li₇P₃S₁₁, Li₁₀GeP₂S₁₂, Li₁₀SnP₂S₁₂.

In some preferred embodiments, the solid electrolyte material may be an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In additional embodiments, the solid electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Ti, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The solid electrolyte material may be present in the second interlayer 106 in an amount from about 0% to about 60% by weight of the second interlayer. For example, the solid electrolyte material may be present in the second interlayer in an amount from about 0% to about 10%, about 0% to about 20%, about 0% to about 30%, about 0% to about 40%, about 0% to about 50%, about 0% to about 60%, about 10% to about 60%, about 20% to about 60%, about 30% to about 60%, about 40% to about 60%, about 50% to about 60%, about 10% to about 50%, or about 20% to about 40% by weight of the second interlayer. In some additional examples, the solid electrolyte material may be present in the second interlayer in an amount of about 0%, about 5%, about 10%, about 15%, about 20%, about 25%, about 30%, about 35%, about 40%, about 45%, about 50%, about 55%, or about 60% by weight of the second interlayer.

In another aspect, the solid electrolyte material may be present in the second interlayer 106 in an amount of no more than 60%, such no more than 5%, no more than 10%, no more than 15%, no more than 20%, no more than 25%, no more than 30%, no more than 35%, no more than 40%, no more than 45%, no more than 50%, no more than 55%, or no more than 60% by weight of the second interlayer.

The second interlayer 106 may have a porosity from about 20% to about 50%. For example, the second interlayer 106 may have a porosity from about 20% to about 25%, about 20% to about 30%, about 20% to about 35%, about 20% to about 40%, about 20% to about 45%, about 20% to about 50%, about 25% to about 50%, about 30% to about 50%, about 35% to about 50%, about 40% to about 50%, about 45% to about 50%, about 25% to about 45%, or about 30% to about 40%.

The second interlayer 106 may have a density from about 0.7 mg/cm³ to about 2 mg/cm³. For example, the second interlayer 106 may have a density from about 0.7 mg/cm³ to about 0.8 mg/cm³, about 0.7 mg/cm³ to about 0.9 mg/cm³, about 0.7 mg/cm³ to about 1.0 mg/cm³, about 0.7 mg/cm³ to about 1.1 mg/cm³, about 0.7 mg/cm³ to about 1.2 mg/cm³, about 0.7 mg/cm³ to about 1.3 mg/cm³, about 0.7 mg/cm³ to about 1.4 mg/cm³, about 0.7 mg/cm³ to about 1.5 mg/cm³, about 0.7 mg/cm³ to about 1.6 mg/cm³, about 0.7 mg/cm³ to about 1.7 mg/cm³, about 0.7 mg/cm³ to about 1.8 mg/cm³, about 0.7 mg/cm³ to about 1.9 mg/cm³, about 0.7 mg/cm³ to about 2.0 mg/cm³, about 0.8 mg/cm³ to about 2.0 mg/cm³, about 0.9 mg/cm³ to about 2.0 mg/cm³, about 1.0 mg/cm³ to about 2.0 mg/cm³, about 1.1 mg/cm³ to about 2.0 mg/cm³, about 1.2 mg/cm³ to about 2.0 mg/cm³, about 1.3 mg/cm³ to about 2.0 mg/cm³, about 1.4 mg/cm³ to about 2.0 mg/cm³, about 1.5 mg/cm³ to about 2.0 mg/cm³, about 1.6 mg/cm³ to about 2.0 mg/cm³, about 1.7 mg/cm³ to about 2.0 mg/cm³, about 1.8 mg/cm³ to about 2.0 mg/cm³, about 1.9 mg/cm³ to about 2.0 mg/cm³, about 1.0 mg/cm³ to about 2.0 mg/cm³, or about 1.0 mg/cm³ to about 1.5 mg/cm³ after densification.

The second interlayer 106 may have a thickness from about 1 micron to about 10 microns before the second interlayer undergoes densification. For example, the second interlayer 106 may have a thickness of about 1 micron, about 2 microns, about 3 microns, about 4 microns, about 5 microns, about 6 microns, about 7 microns, about 8 microns, about 9 microns, or about 10 microns. In some aspects, the second interlayer 106 may have a thickness from about 1 micron to about 2 microns, about 1 micron to about 3 microns, about 1 micron to about 4 microns, about 1 micron to about 5 microns about 1 micron to about 6 microns, about 1 micron to about 7 microns, about 1 micron to about 8 microns, about 1 micron to about 9 microns, about 1 micron to about 10 microns, about 2 microns to about 10 microns, about 3 microns to about 10 microns, about 4 microns to about 10 microns, about 5 microns to about 10 microns, about 6 microns to about 10 microns, about 7 microns to about 10 microns, about 8 microns to about 10 microns or about 9 microns to about 10 microns.

The separator layer 108 is in operable contact with the second interlayer 106 and may be in physical contact with the second interlayer 106. The separator layer 108 (also referred to herein as the “electrolyte layer”) may include one or more solid electrolyte materials. The one or more solid electrolyte materials may comprise an oxide, oxysulfide, sulfide, halide, nitride, or any other solid electrolyte material known in the art. In some preferred embodiments, the one or more solid electrolyte materials may comprise a sulfide solid electrolyte material. In some aspects, the one or more sulfide solid electrolyte material may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SₙP₂S₁₂. In another embodiment, one or more of the solid electrolyte materials may be an argyrodite electrolyte such as Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The solid electrolyte may be present in the separator layer 108 in an amount from about 50% to about 99% by weight of the separator layer 108. For example, the solid electrolyte may be present in the separator layer 108 in an amount from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99%.

The separator layer 108 may additionally comprise one or more binders. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyamide-imide (PAI), polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In preferred embodiments, the binder is a binder is a styrenic block copolymer. In an exemplary embodiment, the binder is SEBS. In another exemplary embodiment, the binder comprises SEBS and SBS.

In some aspects, the binder may be present in the separator layer 108 in an amount of about 0% to about 30% by weight of the separator layer 108; for example, the binder may be present in the separator layer 108 in an amount of about 0% to about 5%, about 0% to about 10%, about 0% to about 15%, about 0% to about 20%, about 0% to about 25%, about 0% to about 30%, about 5% to about 30%, about 10% to about 30%, about 15% to about 30%, about 20% to about 30%, or about 25% to about 30%. In another aspect, the binder may be present in the separator layer in an amount of no more than 5%, no more than 10%, no more than 15%, no more than 20%, no more than 25%, or no more than 30%. In an exemplary embodiment, the binder is present in the separator layer 108 in an amount of about 4% to about 5% by weight.

The separator layer 108 may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

Generally, it is desired to minimize the electronic conductivity of the separator layer. Therefore, in some embodiments, the separator layer 108 comprises no conductive additive, or only trace amounts of a conductive additive.

The cathode layer 110 is in operable contact with the separator layer 108 and may be in physical contact with the cathode layer 110. The cathode layer may include a cathode active material such as (“NMC”) nickel-manganese-cobalt which may be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combination thereof. In still further embodiments, the cathode active material may comprise elemental sulfur(S). In additional embodiments, the cathode active material may comprise one or more of a fluoride, such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The cathode active material may be present in the cathode layer 110 in an amount of up to 99% by weight of the cathode layer. For example, the cathode active material may be present in the cathode layer 110 in an amount from about 1% to about 20%, about 1% to about 40%, about 1% to about 60%, about 1% to about 80%, about 1% to about 99%, about 20% to about 99%, about 40% to about 99%, about 60% to about 99%, about 80% to about 99%, about 20% to about 80%, or about 40% to about 60% by weight of the cathode layer. In another aspect, the cathode active material may be present in the cathode layer 110 in an amount of no more than 10%, no more than 20%, no more than 30%, no more than 40%, no more than 50%, no more than 60%, no more than 70%, no more than 80%, no more than 90%, or no more than 99% by weight of the cathode layer.

The cathode layer 110 may further comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes. In some aspects, the conductive additive may be present in the cathode layer 110 in an amount from about 0% to about 20% by weight of the cathode layer. In some aspects, the conductive additive may be present in the cathode layer 110 in an amount from about 0% to about 5%, about 0% to about 10%, about 0% to about 15%, about 0% to about 20%, about 5% to about 20%, about 10% to about 20%, about 15% to about 20%, or about 5% to about 15% by weight of the cathode layer. In another aspect, the conductive additive may be present in the cathode layer 110 in an amount of no more than 5%, no more than 10%, no more than 15%, or no more than 20% by weight of the cathode layer.

The cathode layer 110 may further comprise one or more solid electrolyte materials. The one or more solid electrolyte material may comprise an oxide, oxysulfide, sulfide, halide, nitride, or any other solid electrolyte material known in the art. In some preferred embodiments, the one or more solid electrolyte materials may comprise a sulfide solid electrolyte material. In some embodiments, the solid electrolyte material comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, the solid electrolyte material may be one or more of a Li₃PS₄, Li₄P₂S₆, Li₇P₃S₁₁, Li₁₀GeP₂S₁₂, Li₁₀SnP₂S₁₂. In a further embodiment, the solid electrolyte material may be an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In additional embodiments, the solid electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In some aspects, the solid state electrolyte may be present in the cathode layer 110 in an amount from about 1% to about 30% by weight of the cathode layer. For example, the solid state electrolyte may be present in the cathode layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, or about 25% to about 30% by weight of the cathode layer.

The cathode layer 110 may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In some aspects, the binder may be present in the cathode layer 110 in an amount from about 0% to about 20% by weight of the cathode layer 110. For example, the binder may be present in the cathode layer in an amount from about 0% to about 5%, about 0% to about 10%, about 0% to about 15%, about 0% to about 20%, about 5% to about 20%, about 10% to about 20%, about 15% to about 20%, or about 5% to about 15% by weight of the cathode layer. In some additional aspects, the binder may be present in the cathode layer in an amount of no more than 5%, no more than 10%, no more than 15%, or no more than 20%.

The cathode layer 110 may have a density from about 1.0 g/cm³ to about 2.0 g/cm³ after densification. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

In some embodiments, the cathode layer 110 may have a thickness from about 10 μm to about 1000 μm. In some aspects, the cathode layer 110 may have a thickness from about 10 μm to about 200 μm, about 10 μm to about 400 μm, about 10 μm to about 600 μm, about 10 μm to about 800 μm, about 10 μm to about 1000 μm, about 200 μm to about 1000 μm, about 400 μm to about 1000 μm, about 600 μm to about 1000 μm, about 800 μm to about 1000 μm, about 200 μm to about 800 μm, or about 400 μm to about 600 μm. In some additional aspects, the electrolyte layer may have a thickness of about 10 μm, 50 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, or about 1000 μm.

The second current collector layer 112 is in operable contact with the cathode layer 110 and may be in physical contact with the cathode layer 110. The second current collector 112 may comprise aluminum, copper, stainless steel, titanium, nickel, or a combination thereof. The second current collector 112 may be coated in a layer of carbon. The second current collector 112 may have a thickness from about 1 μm to about 100 μm. For example, the second current collector 112 may have a thickness from about 1 μm to about 20 μm, about 1 μm to about 40 μm, about 1 μm to about 60 μm, about 1 μm to about 80 μm, about 1 μm to about 100 μm, about 20 μm to about 100 μm, about 40 μm to about 100 μm, about 60 μm to about 100 μm, about 80 μm to about 100 μm, about 20 μm to about 80 μm, or about 40 μm to about 60 μm.

Turning now to FIG. 1C, when a metal carbide material is incorporated into the first interlayer 104, a lithium metal may plate at the interface between the first interlayer 104 and the second interlayer 106, thereby forming a plating layer 115. Without wishing to be bound by theory, as lithium ions from the cathode diffuse into the first interlayer 104, the lithium ions form an alloying reaction with the silver-and silicon-containing materials in the first interlayer 104. Once these materials are fully alloyed with lithium, the lithium ions begin to plate in the space between the first interlayer 104 and second interlayer 104 to form the plating layer 115. This may be driven by the volume expansion of the interlayer which itself is caused by the volume expansion of the silicon containing material after alloying with lithium.

Turning now to FIG. 1D, similar to the embodiment of FIG. 1C, if a metal carbide material is incorporated into the second interlayer 106, a lithium metal may plate at the interface between the second interlayer 106 and the separator 108, thereby forming a plating layer 115.

The compositions described herein may further include additional layers, such as interphase layers, bi-layered electrodes, tri-layered electrodes, bi-layered separators, tri-layered separators, etc.

### B. Single Interlayer Compositions

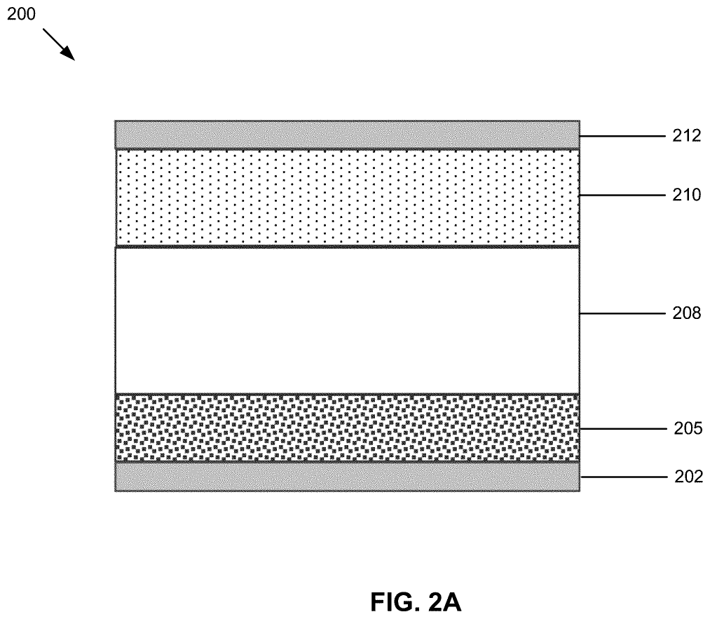

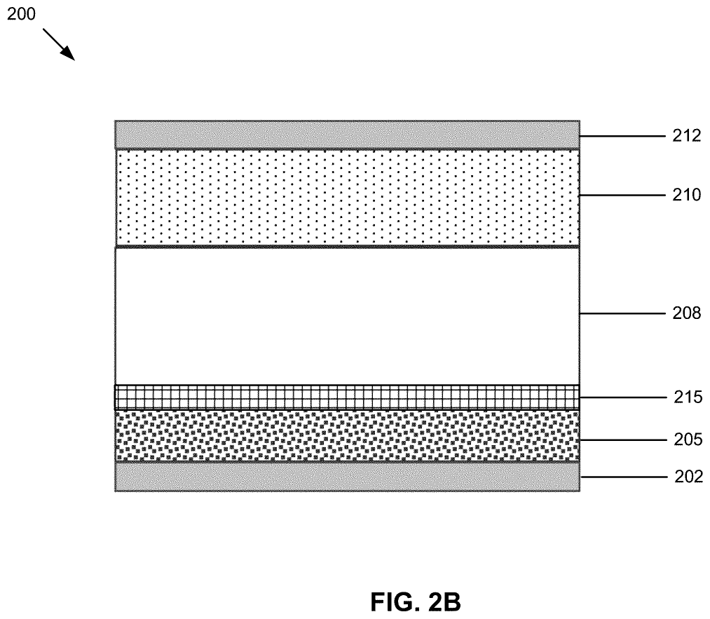

Referring now to FIG. 2A, the composition 200 may comprise a first current collector layer 202, an interlayer 205, a separator layer 208, a cathode layer 210, and a second current collector layer 212. The first current collector layer 202, separator layer 208, cathode layer 210, and the second current collector layer 212 may be the same as those described in Section IA above. In this arrangement, the interlayer 205 may also be referred to as an anode layer.

As shown in FIG. 2, the interlayer 205 is positioned between the separator layer 208 and the first current collector layer 202. The interlayer 205 may be operably coupled with the first current collector layer 202. The separator layer 208 may be operably coupled with the interlayer 205. The cathode layer 210 may be operably coupled with the separator layer 208, and the separator layer 208 is positioned between the interlayer 205 and the cathode layer 210. The second current collector layer 212 may be operably coupled with the cathode layer 210.

In this arrangement shown in FIG. 2, the interlayer 205 may include materials that alloy with lithium and undergo a small volume change. These materials may include metals such as silver, zinc, aluminum, or combinations thereof. In some aspects, the materials that alloy with lithium and undergo a small volume change may be present in an amount from about 0% to about 40% by weight of the interlayer 205. For example, the materials that alloy with lithium and undergo a small volume change may be present in an amount from about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 10% to about 30%, or about 15% to about 25% by weight of the interlayer 205.

The interlayer 205 may further include materials that alloy with lithium and undergo a large volume change, such as silicon, tin, or combinations thereof. Preferably, when the material is silicon, the silicon is nanoscale silicon. In some aspects, the silicon may be present in an amount from about 0% to about 40% by weight of the interlayer 205. For example, the silicon may be present in an amount from about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 10% to about 30%, or about 15% to about 25% by weight of the interlayer 205.

The interlayer 205 may further include materials that do not alloy with lithium but increase the structural integrity of the interlayer. These materials may include a metal carbide such as silicon carbide, titanium carbide, tungsten carbide, or combinations thereof. In some aspects, the materials that do not alloy with lithium but increase the structural integrity of the interlayer may be present in the interlayer in an amount from about 0% to about 20% by weight of the interlayer. For example, the materials that do not alloy with lithium but increase the structural integrity of the interlayer may be present in an amount from about 0% to about 5%, about 0% to about 10%, about 0% to about 15%, about 0% to about 20%, about 5% to about 20%, about 10% to about 20%, about 15% to about 20%, or about 5% to about 15% by weight of the interlayer 205.

Preferably, the interlayer 205 is free of lithium prior to cycling in an electrochemical cell.

The interlayer 205 may have a thickness from about 5 μm to about 30 μm prior to densification. For example, the interlayer 205 may have a thickness from about 5 μm to about 10 μm, about 5 μm to about 15 μm, about 5 μm to about 20 μm, about 5 μm to about 25 μm, about 5 μm to about 30 μm, about 10 μm to about 30 μm, about 15 μm to about 30 μm, about 20 μm to about 30 μm, about 25 μm to about 30 μm, about 10 μm to about 20 μm, or about 15 μm to about 25 μm.

The interlayer 205 may additionally comprise one or more binders. The binder aids in adhesion of the interlayer 205 to the first current collector 202 and increases the structural integrity of the interlayer 205. Additionally, the binder may enable improved cohesion between like particles in different layers of an electrochemical cell. The binder may also form a flexible matrix when mixed with a solid electrolyte material. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In a preferred embodiment, the binder includes PVdF.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In some aspects, the binder may be present in the interlayer 205 in an amount from about 0% to about 30% by weight of the interlayer 205; for example, the binder may be present in the interlayer 205 in an amount of about 0% to about 5%, about 0% to about 10%, about 0% to about 15%, about 0% to about 20%, about 0% to about 25%, about 0% to about 30%, about 5% to about 30%, about 10% to about 30%, about 15% to about 30%, about 20% to about 30%, about 25% to about 30%, or about 10% to about 20% by weight of the interlayer. In an exemplary embodiment, the binder is present in the interlayer 205 in an amount from about 4% to about 5% by weight of the interlayer.

The interlayer 205 may have a porosity from about 20% to about 50%. For example, the interlayer 205 may have a porosity from about 20% to about 25%, about 20% to about 30%, about 20% to about 35%, about 20% to about 40%, about 20% to about 45%, about 20% to about 50%, about 25% to about 50%, about 30% to about 50%, about 35% to about 50%, about 40% to about 50%, about 45% to about 50%, about 25% to about 45%, or about 30% to about 40%.

The interlayer 205 may have a density from about 0.7 mg/cm³ to about 2 mg/cm³. For example, the interlayer 205 may have a density from about 0.7 mg/cm³ to about 0.8 mg/cm³, about 0.7 mg/cm³ to about 0.9 mg/cm³, about 0.7 mg/cm³ to about 1.0 mg/cm³, about 0.7 mg/cm³ to about 1.1 mg/cm³, about 0.7 mg/cm³ to about 1.2 mg/cm³, about 0.7 mg/cm³ to about 1.3 mg/cm³, about 0.7 mg/cm³ to about 1.4 mg/cm³, about 0.7 mg/cm³ to about 1.5 mg/cm³, about 0.7 mg/cm³ to about 1.6 mg/cm³, about 0.7 mg/cm³ to about 1.7 mg/cm³, about 0.7 mg/cm³ to about 1.8 mg/cm³, about 0.7 mg/cm³ to about 1.9 mg/cm³, about 0.7 mg/cm³ to about 2.0 mg/cm³, about 0.8 mg/cm³ to about 2.0 mg/cm³, about 0.9 mg/cm³ to about 2.0 mg/cm³, about 1.0 mg/cm³ to about 2.0 mg/cm³, about 1.1 mg/cm³ to about 2.0 mg/cm³, about 1.2 mg/cm³ to about 2.0 mg/cm³, about 1.3 mg/cm³ to about 2.0 mg/cm³, about 1.4 mg/cm³ to about 2.0 mg/cm³, about 1.5 mg/cm³ to about 2.0 mg/cm³, about 1.6 mg/cm³ to about 2.0 mg/cm³, about 1.7 mg/cm³ to about 2.0 mg/cm³, about 1.8 mg/cm³ to about 2.0 mg/cm³, about 1.9 mg/cm³ to about 2.0 mg/cm³, about 1.0 mg/cm³ to about 2.0 mg/cm³, or about 1.0 mg/cm³ to about 1.5 mg/cm³ after densification.

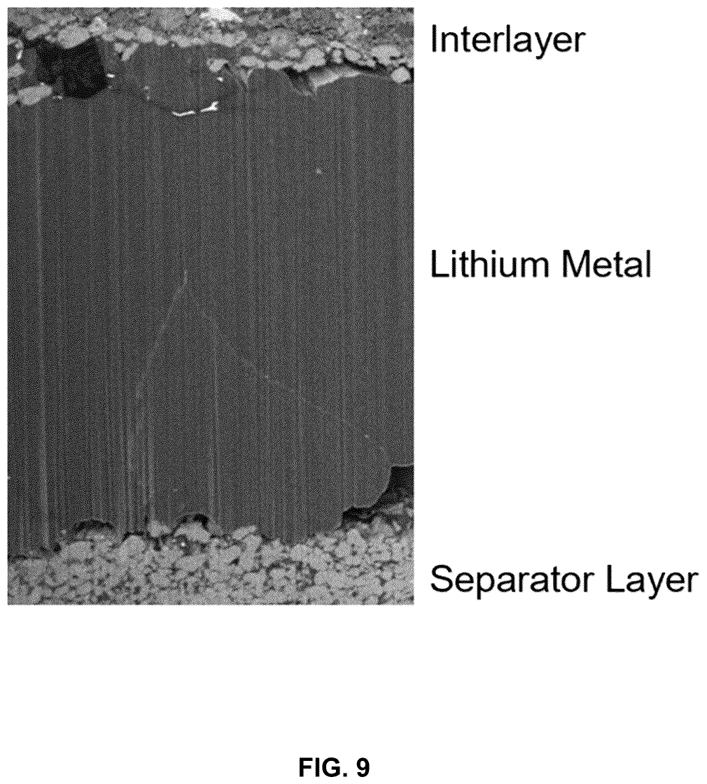

Turning now to FIG. 2B, when a metal carbide material is incorporated into the interlayer 205, a lithium metal may plate at the interface between the interlayer 205 and the separator layer 208, thereby forming a plating layer 215. Without wishing to be bound by theory, as lithium ions from the cathode diffuse into the interlayer 205, the lithium ions form an alloying reaction with the silver-and silicon-containing materials in the interlayer 205. Once these materials are fully alloyed with lithium, the lithium ions begin to plate in the space between the interlayer 205 and separator layer 208 to form the plating layer 215. This may be driven by the volume expansion of the interlayer which itself is caused by the volume expansion of the silicon containing material after alloying with lithium. An SEM image of a composition containing this plating layer is shown in FIG. 9.

When lithium ions are pulled out of the interlayer 205 (cell discharge), the plated lithium metal is converted back into lithium ions and pulled from the interlayer 205, thereby removing the plating layer 215 from the composition 200. Once all of the lithium metal is removed, the interlayer 205 and separator layer 208 make contact again.

Plating the lithium metal between the interlayer 205 and the separator layer 208 may prevent any discontinuity between the interlayer 205 and the first current collector 202. By maintaining a robust interlayer-current collector interface, lower stack pressure and longer cycle life may be achieved. This is in contrast to silicon anodes in solid state cells, the volume expansion of which can promote discontinuities between the silicon anode and the separator layer. This discontinuity increases overall cell resistance and shortens cycle life. The interlayer design of the present disclosure uses the interlayer-separator layer interface to store capacity and promote dense plating of lithium metal which helps to prevent early soft shorting from dendrite formation. Additionally, the interlayer may create a dual alloying/plating system that is more energy dense than standard silicon anodes and that provides longer cycle life.

The compositions described herein may further include additional layers, such as interphase layers, bi-layered electrodes, tri-layered electrodes, bi-layered separators, tri-layered separators, etc.

### II. Electrochemical Cell

Further provided herein is an electrochemical cell. The electrochemical cell may comprise any of the compositions described in Section I above. For example, the electrochemical cell may comprise a first current collector layer, a first interlayer, a second interlayer, a separator layer, a cathode layer, and a second current collector layer. As another example, the current collector may comprise a first current collector layer, an interlayer, a separator layer, a cathode layer, and a second current collector layer.

The electrochemical cell may have a first portion and a second portion. The first portion of the electrochemical cell may comprise the first current collector layer and the interlayer anode composition of the present disclosure. Thus, the first portion of the electrochemical cell may comprise a first current collector layer, a first interlayer, and a second interlayer. Alternatively, the first portion of the electrochemical cell may comprise a first current collector layer and an interlayer. In yet another alternative, the first portion of the electrochemical cell may comprise a first current collector and a first interlayer.

The electrochemical cell may further comprise a second portion. The second portion of the electrochemical cell may comprise a separator layer, a cathode layer, and a second current collector layer. In another embodiment, the second portion of the electrochemical cell may comprise a second interlayer, a separator layer, a cathode layer, and a second current collector layer.

Prior to cycling the electrochemical cell, the anode layer of the electrochemical cell may be free of lithium. Thus, the interlayer or the first interlayer and the second interlayer may be free of lithium before the electrochemical cell is first cycled. After the electrochemical cell is first cycled, the anode layer may comprise lithium. Thus, the interlayer or the first interlayer and the second interlayer may comprise lithium after the electrochemical cell is first cycled.

The electrochemical cell may have a stack pressure of about 10 psi or less, about 25 psi or less, about 50 psi or less, about 100 psi or less, about 150 psi or less, about 300 psi or less, about 500 psi or less, about 1,000 psi or less, about 5,000 psi or less, about 10,000 psi or less, about 50,000 psi or less, or about 100,000 psi or less.

The electrochemical cell of the present disclosure may have a specific capacity of greater than about 50 mAh/g after about 10 cycles. For example, the electrochemical cell of the present disclosure may have a specific capacity of greater than about 50 mAh/g, greater than about 55 mAh/g, greater than about 60 mAh/g, greater than about 65 mAh/g, greater than about 70 mAh/g, greater than about 75 mAh/g, greater than about 80 mAh/g, greater than about 85 mAh/g, or greater than about 90 mAh/g after about 10 cycles, 15 cycles, 20 cycles, 25 cycles, 30 cycles, 35 cycles, 40 cycles, 45 cycles, 50 cycles, or greater than about 50 cycles. In some aspects, the electrochemical cell may have a specific capacity from about 50 mAh/g to about 90 mAh/g after about 10 or more cycles, such as about 50 mAh/g to about 55 mAh/g, about 50 mAh/g to about 60 mAh/g, about 50 mAh/g to about 65 mAh/g, about 50 mAh/g to about 70 mAh/g, about 50 mAh/g to about 75 mAh/g, about 50 mAh/g to about 80 mAh/g, about 50 mAh/g to about 90 mAh/g, about 55 mAh/g to about 90 mAh/g, about 60 mAh/g to about 90 mAh/g, about 65 mAh/g to about 90 mAh/g, about 70 mAh/g to about 90 mAh/g, about 75 mAh/g to about 90 mAh/g, about 80 mAh/g to about 90 mAh/g, or about 85 mAh/g to about 90 mAh/g. The electrochemical cell of the present disclosure may have a capacity greater than 80% of its initial capacity after being cycled about 50 times or more. For example, the electrochemical cell may have a capacity greater than 80% of its initial capacity, greater than 85% of its initial capacity, greater than 90% of its initial capacity, greater than 95% of its initial capacity, or greater than 99% of its initial capacity after being cycled about 50 times, about 75 times, about 100 times, about 125 times, about 150 times, or more than about 150 times. In some aspects, the electrochemical cell may have a capacity from about 80% to about 99% of its initial capacity after being cycled about 50 times or more, such as about 80% to about 85%, about 80% to about 90%, about 80% to about 95%, about 80% to about 99%, about 85% to about 99%, about 90% to about 99%, or about 95% to about 99%.

The electrochemical cell of the present disclosure may have a Coulombic efficiency of greater than about 80% after being cycled about 20 times or more. For example, the electrochemical cell may have a Coulombic efficiency of greater than about 80%, greater than about 85%, greater than about 90%, greater than about 95%, greater than about 96%, greater than about 97%, greater than about 98%, or greater than about 99% for about 20 cycles or more, about 25 cycles or more, about 30 cycles or more, about 35 cycles or more, about 40 cycles or more, about 50 cycles or more. In some aspects, the electrochemical cell may have a Coulombic efficiency from about 80% to about 99% after being cycled about 20 times or more, such as about 80% to about 85%, about 80% to about 90%, about 80% to about 95%, about 80% to about 99%, about 85% to about 99%, about 90% to about 99%, or about 95% to about 99%.

### III. Methods

Provided herein is a method of making a composition for use in an electrochemical cell. The electrochemical cell may be any electrochemical cell described in Section II above. The method comprises coating a first interlayer composition onto a first current collector layer, coating a second interlayer composition onto the first interlayer composition, thereby forming a first portion of the electrochemical cell. The method may further comprise laminating the first portion of the electrochemical cell with a second portion of the electrochemical cell. The lamination may occur such that the second interlayer of the first portion of the electrochemical cell is in operable contact with the separator layer of the second portion of the electrochemical cell. The coating may be accomplished by various coating and casting methods known in the art, such as tape casting.

Alternatively, the method comprises coating an interlayer composition onto a first current collector layer, thereby forming a first portion of the electrochemical cell. The method may further comprise laminating the first portion of the electrochemical cell with a second portion of the electrochemical cell. The lamination may occur such that the interlayer of the first portion of the electrochemical cell is in operable contact with the separator layer of the second portion of the electrochemical cell.

In an alternative embodiment, the method may comprise coating any of the layers of the electrochemical cell onto a carrier foil, and then transferring the coated layer from the carrier foil. For example, the method may comprise coating a first interlayer composition onto a carrier foil and transferring the first interlayer composition from the carrier foil to a first current collector layer via lamination. The method may further comprise coating a second interlayer composition onto the first interlayer composition, thereby forming the first portion of the electrochemical cell. Alternatively, the method may further comprise coating the second interlayer composition onto a carrier foil and transferring the second interlayer composition onto the first interlayer composition, thereby forming the first portion of the electrochemical cell. The first portion of the electrochemical cell may then be laminated with a second portion of the electrochemical cell.

Further provided herein is a method of making an electrochemical cell. The method comprises coating an interlayer onto a current collector, wherein the interlayer comprises a binder; coating a separator layer onto the interlayer before the interlayer has dried, wherein the separator layer does not comprise a binder when it is coated; and drying the separator layer and the interlayer. As the interlayer and the separator dry, the evaporating solvent pulls the binder upward from the interlayer into the separator layer through advection. Therefore, the dried separator layer comprises the binder.

Coating the various layers may be accomplished by forming a slurry. The slurry is created by combining the materials used in each respective layer to form a composite mixture, and then adding a solvent to the composite mixture to form a slurry. As such, the first interlayer slurry may comprise a metal, a mixture of carbon materials, a metal carbide, and/or a binder. The second interlayer slurry may comprise carbon materials, silicon, a binder, and/or a solid electrolyte material. The separator slurry may comprise a solid electrolyte material and a binder. The cathode slurry may comprise a cathode active material, a solid electrolyte material, a binder, and/or a conductive additive.

The solvent may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

Further provided herein is a method of making an electrochemical cell. The method comprises coating an interlayer onto a current collector, wherein the interlayer comprises a first binder; coating a separator layer onto the interlayer before the interlayer has dried, wherein the separator layer comprises a second binder; and drying the separator layer and the interlayer. As the interlayer and the separator dry, the evaporating solvent pulls the first binder upward from the interlayer into the separator layer through advection. Therefore, the dried separator layer comprises the binder.

Substantially removing the one or more solvent may be accomplished by methods known in the art, including by drying or by adjusting ambient temperature or pressure to induce or accelerate evaporation of the one or more solvent. As used herein “substantially removing the one or more solvent” means that the final composition comprises essentially no solvent (i.e., less than 1% by weight of the one or more solvents). In preferred embodiments, the final composition comprises less than 0.1% by weight of the one or more solvents. In more preferred embodiments, the final composition comprises no solvent.

In some embodiments, the method may further include pressing one or more of the layers of the electrochemical cell. The pressing may include pressing a single layer or may include pressing two or more of the layers. The pressing may be accomplished using methods known in the art, such as laminating, calendaring or machine pressing.

The pressing may be accomplished at a pressure from about 100 psi to about 500,000 psi. For example, the pressing may be accomplished from about 100 psi to about 500 psi, about 500 psi to about 1,000 psi, about 1,000 psi, about 1,000 psi to about 5,000 psi, about 5,000 psi to about 10,000 psi, about 10,000 psi to about 50,000 psi, about 50,000 psi to about 100,000 psi, about 100 psi to about 1,000 psi, about 100 psi to about 5,000 psi, about 100 psi to about 10,000 psi, about 100 psi to about 50,000 psi, about 100 psi to about 100,000 psi, about 500 psi to about 100,000 psi, about 1,000 psi to about 100,000 psi, about 5,000 psi to about 100,000 psi, about 10,000 psi to about 100,000 psi, or about 50,000 psi to about 100,000 psi.

Further provided herein is a method of producing layers for use in a solid-state electrochemical cell. The method comprises producing a first layer and a second layer in slurry form, each layer comprising one or more solvents; coating the first layer onto a carrier foil or a current collector; coating the second layer onto the carrier foil or current collector in close proximity to the first layer; increasing a surface-to-surface contact of the first layer and the second layer; and substantially removing the one or more solvents. Coating may be accomplished by tape casting. Systems and methods for tape casting are generally known in the art. Each of the layers may be an interlayer or a separator layer as described herein. In some embodiments, the first layer is an interlayer and the second layer is a separator layer.

When the first layer is an anode layer, the carrier foil may comprise copper, nickel, stainless steel, lithium alloys, or carbon fiber. In some aspects, the carrier foil may be coated with carbon.

When the first layer is a cathode layer, the carrier foil may comprise aluminum, copper, or stainless steel.

The one or more solvents may be any of the solvents described herein. The one or more solvents may comprise a dissolved binder, which may be any binder described herein.

Substantially removing the one or more solvent may be accomplished by methods known in the art, including by drying or by adjusting ambient temperature or pressure to induce or accelerate evaporation of the one or more solvent. The method may further comprise generating a capillary effect through the first layer and the second layer. The capillary effect may be generated by evaporation of the one or more solvents. In order to generate the capillary effect, the binders must be soluble in the solvent that is used. If the binder is not dissolved, it will be unable to move within the layers. Additionally, the layers must have sufficient porosity to allow the binder to travel during the drying process.

In embodiments where the layers are dried, the dried interlayers may be incorporated into an electrochemical cell or battery. In some embodiments, the battery may comprise layers, wherein each layer has at least one solid-to-solid interface with another layer of the battery. For example, a battery may include a solid anode layer, a solid separator layer, and a solid cathode layer, each layer having a solid-to-solid interface between each layer.

The surface-to-surface contact of the first and second layer may be increased by pressing methods described herein and known in the art.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

### ENUMERATED EMBODIMENTS

Embodiment 1: A composition for use in an electrochemical cell comprising:
a first current collector layer;
a first interlayer having a thickness of about 1 micron to about 10 microns;
a second interlayer having a thickness of about 1 micron to about 10 microns;
wherein the first interlayer and the second interlayer are positioned between the first current collector layer and the separator layer;
a separator layer;
a cathode layer; and
a second current collector layer.

Embodiment 2: The composition of embodiment 1, wherein the first interlayer comprises a mixture of carbon materials.

Embodiment 3: The composition of embodiment 1 or 2, wherein the first interlayer comprises a metal selected from the group consisting of silver, zinc, aluminum, magnesium, tin, antimony, and combinations thereof.

Embodiment 4: The composition of embodiment 3, wherein the metal has an average particle size of less than about 900 nm.

Embodiment 5: The composition of any one of embodiments 1-4, wherein the first interlayer comprises a binder.

Embodiment 6: The composition of any one of embodiments 1-5, wherein the first interlayer comprises a metal carbide selected from the group consisting of silicon carbide (SiC), titanium carbide (TiC), tungsten carbide (WC).

Embodiment 7: The composition of embodiment 6, wherein the metal carbide has an average particle size of less than about 1 μm.

Embodiment 8: The composition of any one of embodiments 1-7, wherein the second interlayer comprises silicon.

Embodiment 9: The composition of any one of embodiments 1-8, wherein the second interlayer comprises carbon materials.

Embodiment 10: The composition of any one of embodiments 1-9, wherein the second interlayer comprises a binder.

Embodiment 11: The composition of any one of embodiments 1-10, wherein the first interlayer has a porosity of about 20% to about 50%.

Embodiment 12: The composition of any one of embodiments 1-11, wherein the second interlayer has a porosity of about 20% to about 50%.

Embodiment 13: The composition of any one of embodiments 1-12, wherein the thickness of the first interlayer and the second interlayer is measured before densification.

Embodiment 14: The composition of any one of embodiments 1-13, wherein the electrochemical cell has a stack pressure of about 300 psi or less.

Embodiment 15: The composition of any one of embodiments 1-14, wherein the metal has a concentration in the first interlayer from about 5 wt % to about 50 wt %.

Embodiment 16: The composition of embodiment 15, wherein the metal has a concentration in the first interlayer of about 30 wt %.

Embodiment 17: The composition of any one of embodiments 1-16, wherein the first interlayer and the second interlayer are free of lithium (Li).

Embodiment 18: The composition of any one of embodiments 1-17, wherein the first interlayer and the second interlayer are free of lithium (Li) before the electrochemical cell is first cycled.

Embodiment 19: The composition of any one of embodiments 1-18, wherein the first interlayer and/or the second interlayer comprise lithium after the electrochemical cell is first cycled.

Embodiment 20: The composition of any one of embodiments 1-19, wherein the separator layer comprises a solid electrolyte material.

Embodiment 21: The composition of embodiment 20, wherein the solid electrolyte material is a sulfide solid electrolyte material.

Embodiment 22: The composition of any one of embodiments 1-21, wherein the cathode layer comprises a cathode active material.

Embodiment 23: The composition of embodiment 22, wherein the cathode active material comprises a coated or uncoated metal sulfide, a fluoride, and/or nickel-manganese-cobalt.

Embodiment 24: The composition of embodiment 22 or 23, wherein the cathode active material comprises lithium.

Embodiment 25: The composition of any one of embodiments 1-24, wherein the cathode layer comprises a conductive additive.

Embodiment 26: The composition of any one of embodiments 1-25, wherein the cathode layer comprises a binder.

Embodiment 27: The composition of any one of embodiments 1-26, wherein the cathode layer comprises a solid electrolyte material.

Embodiment 28: The composition of any one of embodiments 1-27, wherein the first current collector layer comprises copper and a thin layer of copper oxide.

Embodiment 29: The composition of any one of embodiments 1-28, wherein the first interlayer is operably coupled with the first current collector layer.

Embodiment 30: The composition of any one of embodiments 1-29, wherein the first interlayer is operably coupled with the second interlayer.

Embodiment 31: The composition of any one of embodiments 1-30, wherein the separator layer is operably coupled with the second interlayer.

Embodiment 32: The composition of any one of embodiments 1-31, wherein the cathode layer is operably coupled with the separator layer, and the separator layer is positioned between the second interlayer and the cathode layer.

Embodiment 33: The composition of any one of embodiments 1-32, wherein the second current collector layer is operably coupled with the cathode layer.

Embodiment 34: The composition of any one of embodiments 1-33, further comprising a plating layer positioned between the second interlayer and the separator layer.

Embodiment 35: The composition of embodiment 34, wherein the plating layer comprises lithium metal.

Embodiment 36: The composition of any one of embodiments 1-33, further comprising a plating layer positioned between the first interlayer and the second interlayer.

Embodiment 37: The composition of embodiment 36, wherein the plating layer comprises lithium metal.

Embodiment 38: A composition for use in an electrochemical cell comprising:
a first current collector layer;
an interlayer having a thickness of about 1 micron to about 10 microns;
a separator layer;
wherein the interlayer is positioned between the first current collector layer and the separator layer;
a cathode layer; and
a second current collector layer.

Embodiment 39: The composition of embodiment 38, wherein the interlayer comprises a metal selected from the group consisting of silver, zinc, aluminum, magnesium, tin, antimony, and combinations thereof.

Embodiment 40: The composition of embodiment 38 or 39, wherein the interlayer comprises a metal selected from the group consisting of silicon, tin, and combinations thereof.

Embodiment 41: The composition of any one of embodiments 38-40, wherein the interlayer comprises a metal carbide selected from the group consisting of silicon carbide, titanium carbide, tungsten carbide, and combinations thereof.

Embodiment 42: The composition of any one of embodiments 38-41, wherein the interlayer has a porosity of about 20% to about 50%.

Embodiment 43: The composition of any one of embodiments 38-42, wherein the interlayer has a porosity of about 30% to about 40%.

Embodiment 44: The composition of any one of embodiments 38-43, wherein the thickness of the interlayer is measured before densification.

Embodiment 45: The composition of any one of embodiments 38-44, wherein the interlayer is operably coupled with the first current collector layer.

Embodiment 46: The composition of any one of embodiments 38-45, wherein the separator layer is operably coupled with the interlayer.

Embodiment 47: The composition of any one of embodiments 38-46, wherein the cathode layer is operably coupled with the separator layer, and the separator layer is positioned between the interlayer and the cathode layer.

Embodiment 48: The composition of any one of embodiments 38-47, wherein the second current collector layer is operably coupled with the cathode layer.

Embodiment 49: The composition of any one of embodiments 38-48, further comprising a plating layer positioned between the interlayer and the separator layer.

Embodiment 50: The composition of embodiment 49, wherein the plating layer comprises lithium metal.

Embodiment 51: A composition for use in an electrochemical cell comprising:
a first current collector layer;
an anode layer, the anode layer comprising:
   a first interlayer having a thickness of about 1 micron to about 10 microns, and
   a second interlayer having a thickness of about 1 micron to about 10 microns;
a separator layer;
wherein the anode layer is positioned between the first current collector layer and the separator layer;
a cathode layer; and
a second current collector layer.

Embodiment 52: The composition of embodiment 51, wherein the anode layer is free of lithium.

Embodiment 53: The composition of embodiment 51 or 52, wherein the anode layer is free of lithium before the electrochemical cell is first cycled.

Embodiment 54: The composition of any one of embodiments 51-53, wherein the anode layer comprises lithium after the electrochemical cell is cycled.

Embodiment 55: The composition of any one of embodiments 51-54, wherein the anode layer is operably coupled with the first current collector layer.

Embodiment 56: The composition of any one of embodiments 51-55, wherein the first interlayer is operably coupled with the second interlayer.

Embodiment 57: The composition of any one of embodiments 51-56, wherein the separator layer is operably coupled with the anode layer.

Embodiment 58: The composition of any one of embodiments 51-57, wherein the cathode layer is operably coupled with the separator layer, and the separator layer is positioned between the anode layer and the cathode layer.

Embodiment 59: The composition of any one of embodiments 51-58, wherein the second current collector layer is operably coupled with the cathode layer.

Embodiment 60: An electrochemical cell comprising a composition of any one of embodiments 1-59.

Embodiment 61: An electrochemical cell comprising:
a first current collector layer;
a first interlayer;
a second interlayer;
a separator layer;
wherein the first interlayer and the second interlayer are positioned between the first current collector layer and the separator layer;
a cathode layer; and
a second current collector layer.

Embodiment 62: The electrochemical cell of embodiment 61, wherein the electrochemical cell has a stack pressure of about 300 psi or less.

Embodiment 63: The electrochemical cell of embodiment 61 or 62, wherein the first interlayer and the second interlayer are free of lithium (Li) before the electrochemical cell is first cycled.

Embodiment 64: The electrochemical cell of any one of embodiments 61-63, wherein the first interlayer and/or the second interlayer comprise lithium after the electrochemical cell is first cycled.

Embodiment 65: The electrochemical cell of any one of embodiments 61-64, wherein the electrochemical cell has a specific capacity of greater than 50 mAh/g after about 30 cycles.

Embodiment 66: The electrochemical cell of any one of embodiments 61-65, wherein the electrochemical cell has a specific capacity of greater than 70 mAh/g after about 30 cycles.

Embodiment 67: The electrochemical cell of any one of embodiments 61-66, wherein the electrochemical cell has a capacity greater than 80% of its initial capacity after being cycled about 50 times or more.

Embodiment 68: The electrochemical cell of any one of embodiments 61-67, wherein the electrochemical cell has a capacity greater than 80% of its initial capacity after being cycled about 100 times or more.

Embodiment 69: The electrochemical cell of any one of embodiments 61-68, wherein the electrochemical cell has a capacity greater than 80% of its initial capacity after being cycled about 150 times or more.

Embodiment 70: The electrochemical cell of any one of embodiments 61-69, wherein the electrochemical cell has a coulombic efficiency of greater than about 80% after being cycled about 20 times or more.

Embodiment 71: The electrochemical cell of any one of embodiments 61-70, wherein the electrochemical cell has a coulombic efficiency of greater than about 85% after being cycled about 20 times or more.

Embodiment 72: The electrochemical cell of any one of embodiments 61-71, wherein the electrochemical cell has a coulombic efficiency of greater than about 90% after being cycled about 20 times or more.

Embodiment 73: The electrochemical cell of any one of embodiments 61-72, wherein the electrochemical cell has a coulombic efficiency of greater than about 95% after being cycled about 20 times or more.

Embodiment 74: The electrochemical cell of any one of embodiments 61-73, wherein the electrochemical cell has a coulombic efficiency of greater than about 98% after being cycled about 20 times or more.

Embodiment 75: The electrochemical cell of any one of embodiments 61-74, wherein the electrochemical cell has a coulombic efficiency of greater than about 80% after being cycled about 40 times or more.

Embodiment 76: The electrochemical cell of any one of embodiments 61-75, wherein the electrochemical cell has a coulombic efficiency of greater than about 85% after being cycled about 40 times or more.

Embodiment 77: The electrochemical cell of any one of embodiments 61-76, wherein the electrochemical cell has a coulombic efficiency of greater than about 90% after being cycled about 40 times or more.

Embodiment 78: The electrochemical cell of any one of embodiments 61-77, wherein the electrochemical cell has a coulombic efficiency of greater than about 95% after being cycled about 40 times or more.

Embodiment 79: The electrochemical cell of any one of embodiments 61-78, wherein the electrochemical cell has a coulombic efficiency of greater than about 98% after being cycled about 40 times or more.

Embodiment 80: An electrochemical cell comprising:
a first current collector layer;
an interlayer;
a separator layer;
wherein the interlayer is positioned between the first current collector layer and the separator layer;
a cathode layer; and
a second current collector layer.

Embodiment 81: An electrochemical cell comprising:
a first current collector layer;
an anode layer including:
a first interlayer; and
a second interlayer;
a separator layer;
wherein the anode layer is positioned between the first current collector layer and the separator layer;
a cathode layer; and
a second current collector layer.

Embodiment 82: A method of making an electrochemical cell, the method comprising:
coating a first interlayer composition onto a first current collector;
coating a second interlayer composition onto the first interlayer composition, thereby forming a first portion of the electrochemical cell; and
laminating the first portion of the electrochemical cell with a second portion of the electrochemical cell.

Embodiment 83: A method of making an electrochemical cell, the method comprising:
coating a first interlayer composition onto a carrier foil;
transferring the first interlayer composition from the carrier foil to a first current collector via lamination;
coating a second interlayer composition onto the first interlayer composition, thereby forming a first portion of the electrochemical cell; and
laminating the first portion of the electrochemical cell with a second portion of the electrochemical cell.

Embodiment 84: A method of making an electrochemical cell, the method comprising:
coating a first interlayer composition onto a carrier foil;
transferring the first interlayer composition from the carrier foil to a first current collector via lamination;
coating a second interlayer composition onto a carrier foil;
transferring the second interlayer composition onto the first interlayer composition, thereby forming a first portion of the electrochemical cell; and
laminating the first portion of the electrochemical cell with a second portion of the electrochemical cell.

Embodiment 85: A method of making an electrochemical cell, the method comprising:
coating a first interlayer composition onto a carrier foil;
transferring the first interlayer composition from the carrier foil to a first current collector
via lamination, thereby forming a first portion of an electrochemical cell;
coating a second interlayer composition onto a solid electrolyte composition, thereby forming a second portion of the electrochemical cell; and
laminating the first portion and the second portion such that the first interlayer composition and the second interlayer composition are in physical contact.

Embodiment 86: A method of making an electrochemical cell, the method comprising:
coating an interlayer composition onto a first current collector, thereby forming a first portion of the electrochemical cell; and
laminating the first portion of the electrochemical cell with a second portion of the electrochemical cell.

Embodiment 87: A method of making an electrochemical cell, the method comprising:
coating an interlayer composition onto a carrier foil;
transferring the interlayer composition from the carrier foil to a first current collector via lamination, thereby forming a first portion of the electrochemical cell; and
laminating the first portion of the electrochemical cell with a second portion of the electrochemical cell.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1: Electrochemical Cell Performance

An electrochemical cell was made with a two-interlayer anode composition of the present disclosure. The cathode used in the electrochemical cell included 80 wt % NMC622, and the separator layer included a sulfide-based solid state electrolyte. In the following examples, all electrochemical cells used the same cathode and separator layer.

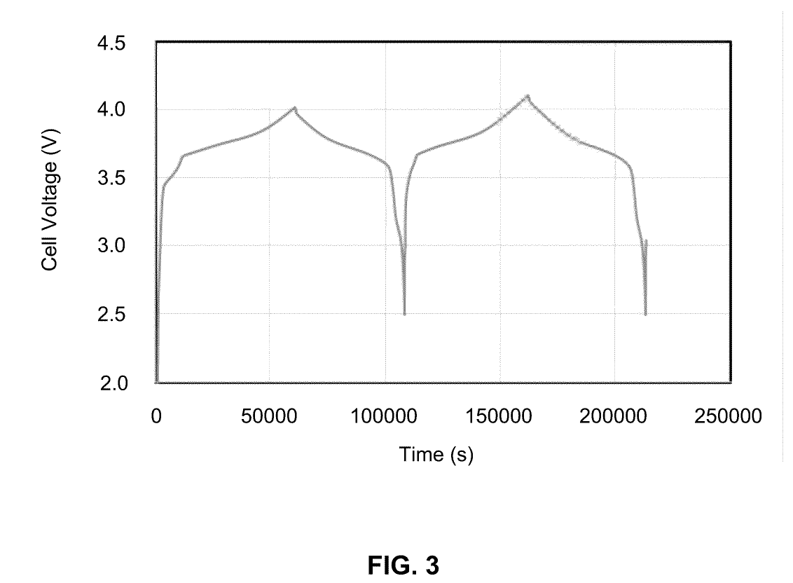

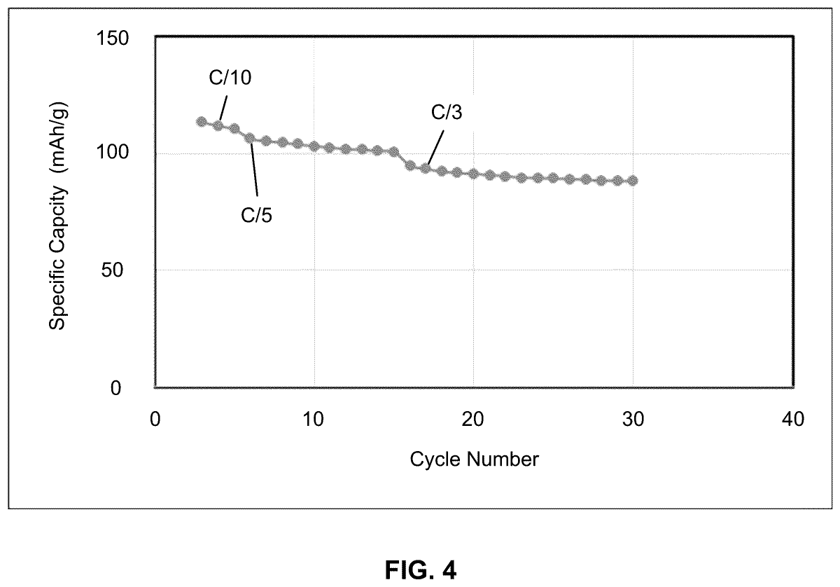

The first interlayer included silicon (23 wt %), carbon (63 wt %), and a PVDF binder (14 wt %). The second interlayer included carbon (74 wt %), silicon carbide (12%), and a PVDF binder (14%). The two interlayers were present in about a 1:1 weight ratio. The electrochemical cell was cycled at C/20, 4.2-2.5V, at 45° C. and a stack pressure of about 150 psi. The voltage during cycling is shown in FIG. 3. The specific capacity of the electrochemical cell is shown in FIG. 4.

### Example 2: Electrochemical Cell Performance

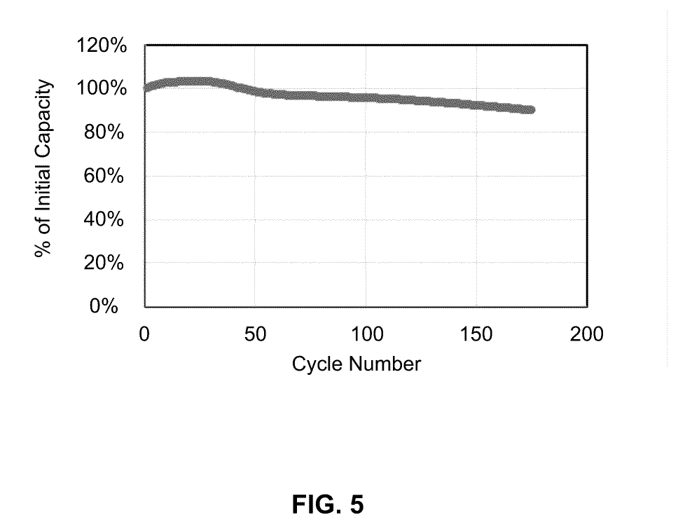

An electrochemical cell was made with a two-interlayer anode composition of the present disclosure. The first interlayer included silicon (31 wt %), carbon (8 wt %), a sulfide solid electrolyte material (51 wt %), and a SEBS binder (10 wt %). The weight of the first interlayer was about 1.4 mg/cm². The second interlayer included silver (32%), carbon (54%), and a PVDF binder (14%). The weight of the second interlayer was about 0.3 mg/cm². The electrochemical cell was cycled at C/5, 4.2-2.5 V, at 45° C. and a stack pressure of about 150 psi. The capacity retention of the electrochemical cell is shown in FIG. 5.

### Example 3: Electrochemical Cell Performance

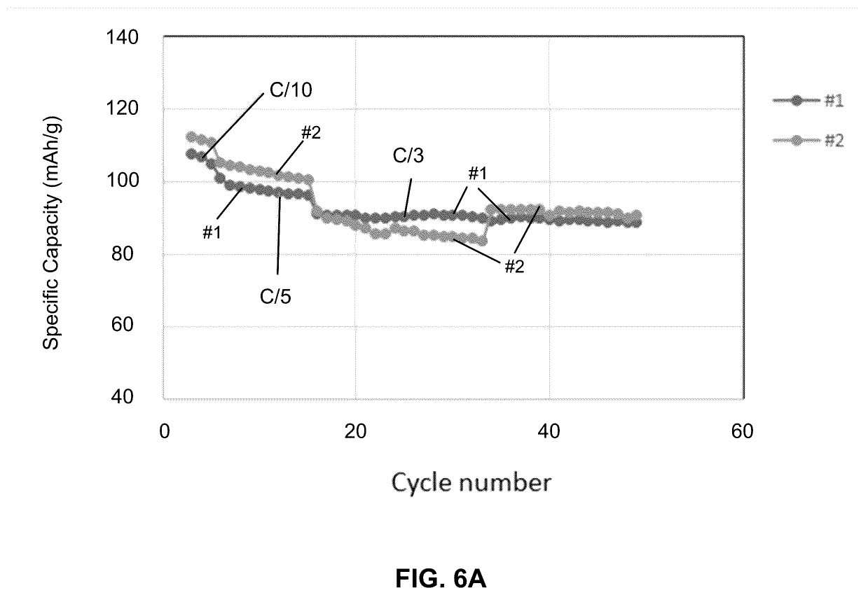

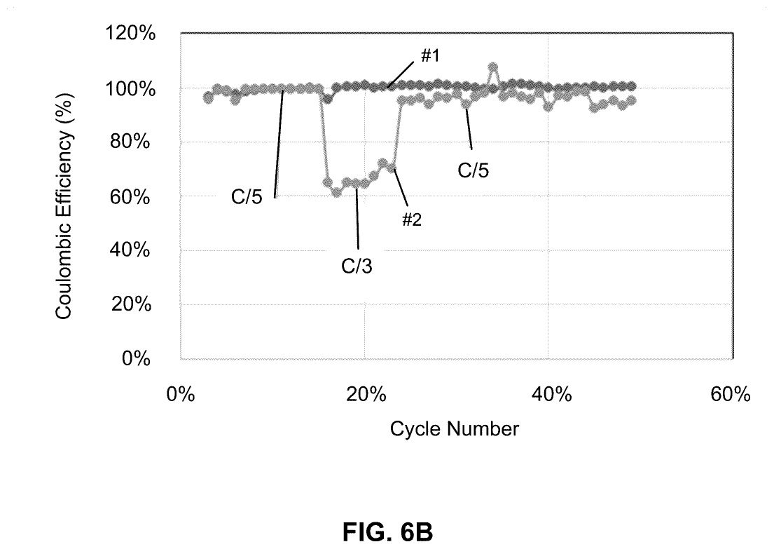

Electrochemical cells were made with one-interlayer anode compositions of the present disclosure. The first electrochemical cell had an interlayer that included silicon (15 wt %), silver (16 wt %), carbon (54 wt %), and polyamide-imide (PAI, 15 wt %). The interlayer of the first electrochemical cell weighed about 0.9 mg/cm². The second electrochemical cell had an interlayer that included silicon (18 wt %), carbon (66 wt %), and PAI (16 wt %). The interlayer of the second electrochemical cell weighed about 0.6 mg/cm². The cells were cycled at 45° C., 4.2-2.5 V, and a stack pressure of about 150 psi. The cycling rates were C/10, C/5, and C/3. The specific capacity of the cells is shown in FIG. 6A. The coulombic efficiency of the cells is shown in FIG. 6B.

### Example 4: Electrochemical Cell Performance

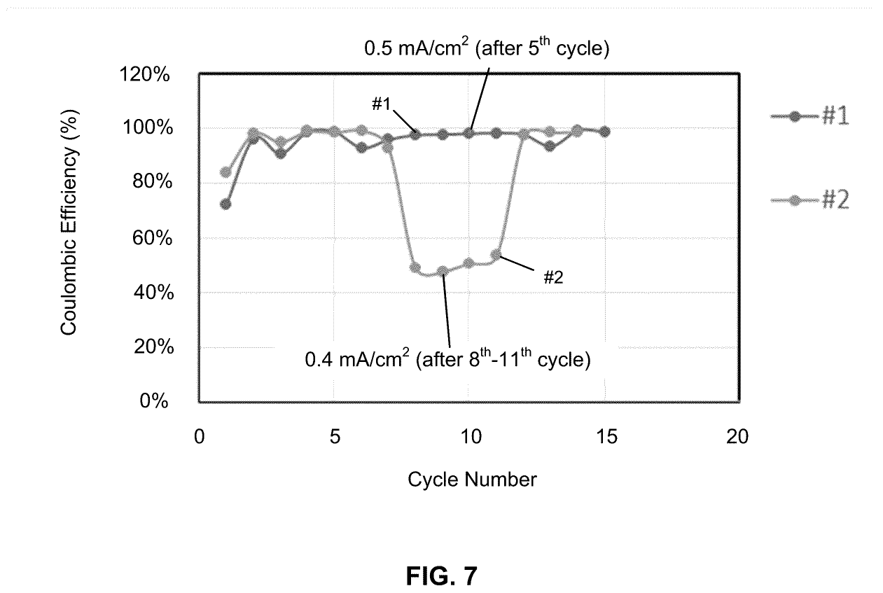

Electrochemical cells were made with one-interlayer anode compositions of the present disclosure. The first electrochemical cell had an interlayer that included silicon (15 wt %), silver (16 wt %), carbon (54 wt %), and PAI (15 wt %). The interlayer weighed 0.8 mg/cm². This cell (#1) was tested at three different current densities: 0.15 mA/cm² (two cycles), 0.3 mA/cm² (three cycles), then 0.5 mA/cm². The cell's coulombic efficiency was good at these current densities and is shown in FIG. 7.

The second electrochemical cell had an interlayer that included silver (31 wt %), carbon (54 wt %) and PAI (15 wt %). The interlayer weighed 0.8 mg/cm². The second cell (#2) was tested at two current densities: 0.2 mA/cm2 and 0.4 mA/cm2. At 0.4 mA/cm2, its coulombic efficiency dropped as shown in FIG. 7, where the test temperature was 25° C., the cell stack pressure was 150 psi, and the cycle window was 4.2-2.5V. The comparison of these two cells indicates the combination of Ag and Si achieves better performance.

### Example 5: Electrochemical Cell Performance

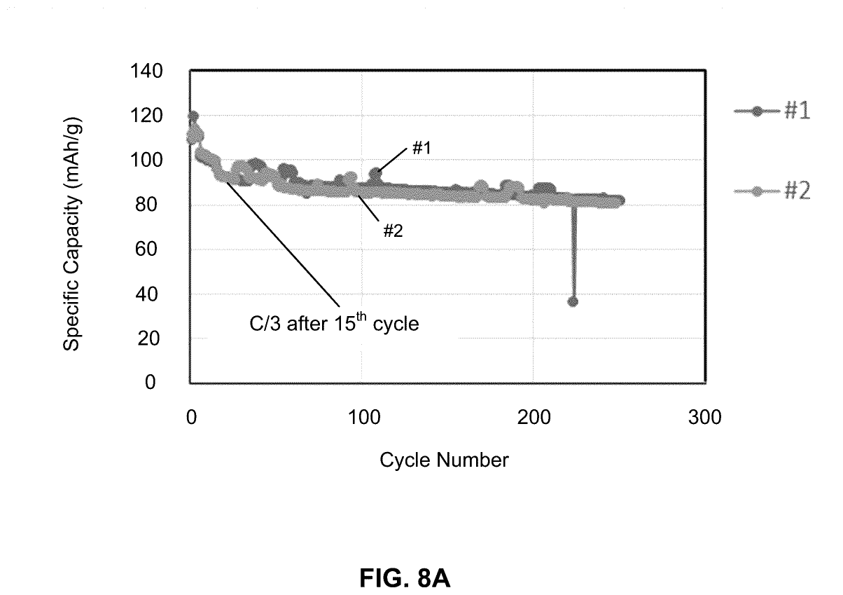

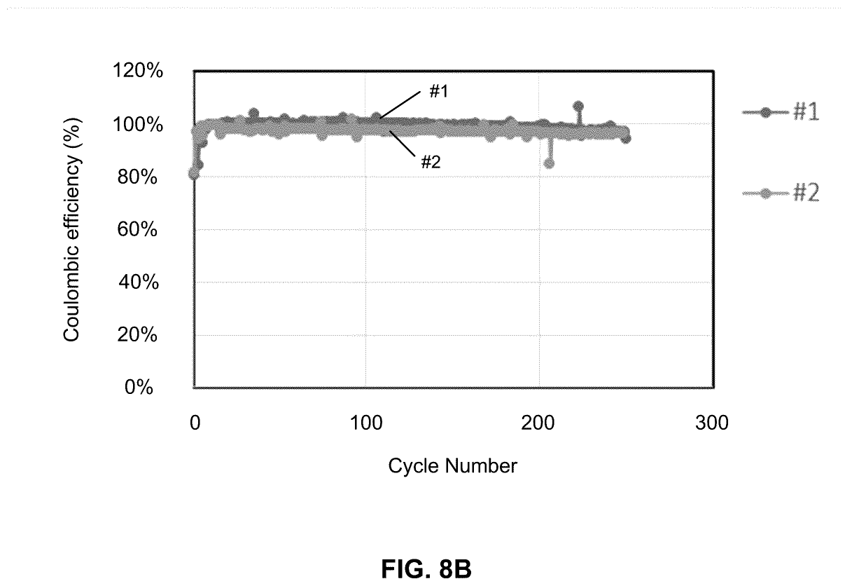

Electrochemical cells were made with one-interlayer anode compositions of the present disclosure. The first electrochemical cell had an interlayer that included silicon (15 wt %), silver (15 wt %), carbon (55 wt %) and PAI (20 wt %). The interlayer weighed 0.8 mg/cm². The second electrochemical cell had an interlayer that included silicon (15 wt %), silver (15 wt %), silicon carbide (7 wt %), carbon (44 wt %) and PAI (20 wt %). The interlayer weighed 0.8 mg/cm². The cells were cycled at 25° C., voltage window of 4.2-2.5 V, and a stack pressure of 300 psi. After C/20, C/10 and C/5, a C/3 rate started after 15 cycles. The specific capacity (based on cathode weight) and coulombic efficiency upon cycling are provided in FIGS. 8A and 8B, respectively. The comparison of these two cells indicates that SiC can be introduced into the interlayer to replace carbon as a loading material.

A SEM image of the electrochemical cell is shown in FIG. 9. FIG. 9 shows lithium metal plated at an interface between the interlayer and the separator layer.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A composition for use in an electrochemical cell comprising:
a first current collector layer;
a first interlayer having a thickness of about 1 micron to about 10 microns;
a second interlayer having a thickness of about 1 micron to about 10 microns;
wherein the first interlayer and the second interlayer are positioned between the first current collector layer and the separator layer;
a separator layer;
a cathode layer; and
a second current collector layer.

2. The composition of claim 1, wherein the first interlayer comprises a mixture of carbon materials.

3. The composition of claim 1, wherein the first interlayer comprises a metal selected from the group consisting of silver, zinc, aluminum, magnesium, tin, antimony, and combinations thereof.

4. The composition of claim 3, wherein the metal has an average particle size of less than about 900 nm.

5. The composition of claim 1, wherein the first interlayer comprises a binder.

6. The composition of claim 1, wherein the first interlayer comprises a metal carbide selected from the group consisting of silicon carbide (SiC), titanium carbide (TiC), tungsten carbide (WC).

7. The composition of claim 6, wherein the metal carbide has an average particle size of less than about 1 μm.

8. The composition of claim 1, wherein the second interlayer comprises silicon.

9. The composition of claim 1, wherein the second interlayer comprises carbon materials.

10. The composition of claim 1, wherein the second interlayer comprises a binder.

11. The composition of claim 1, wherein the thickness of the first interlayer and the second interlayer is measured before densification.

12. The composition of claim 3, wherein the metal has a concentration in the first interlayer from about 5 wt % to about 50 wt %.

13. The composition of claim 1, wherein the first interlayer and the second interlayer are free of lithium (Li).

14. The composition of claim 1, wherein the first interlayer and/or the second interlayer comprise lithium after the electrochemical cell is first cycled.

15. The composition of claim 1, wherein the first current collector layer comprises copper and a thin layer of copper oxide.

16. The composition of claim 1, further comprising a plating layer positioned between the second interlayer and the separator layer.

17. The composition of claim 1, further comprising a plating layer positioned between the first interlayer and the second interlayer.

18. A composition for use in an electrochemical cell comprising:
a first current collector layer;
an interlayer having a thickness of about 1 micron to about 10 microns;
a separator layer;
wherein the interlayer is positioned between the first current collector layer and the separator layer;
a cathode layer; and
a second current collector layer.

19. The composition of claim 18, wherein the interlayer comprises a metal selected from the group consisting of silver, zinc, aluminum, magnesium, tin, antimony, and combinations thereof.

20. The composition of claim 18, wherein the interlayer comprises a metal selected from the group consisting of silicon, tin, and combinations thereof.

21. The composition of claim 18, wherein the interlayer comprises a metal carbide selected from the group consisting of silicon carbide, titanium carbide, tungsten carbide, and combinations thereof.

22. The composition of claim 18, further comprising a plating layer positioned between the interlayer and the separator layer.

23. The composition of claim 22, wherein the plating layer comprises lithium metal.

24. A method of making an electrochemical cell, the method comprising:
coating a first interlayer composition onto a first current collector;
coating a second interlayer composition onto the first interlayer composition, thereby forming a first portion of the electrochemical cell; and
laminating the first portion of the electrochemical cell with a second portion of the electrochemical cell.
